(19) United States
(12) Patent Application Publication
(10) Pub. No.: US 2026/0120567 A1
(43) Pub. Date: Apr. 30, 2026

(54) TRAFFIC LIGHT CHANGING SYSTEM

(71) Applicant: Sean Hill, Deland, FL (US)

(72) Inventor: Sean Hill, Deland, FL (US)

(21) Appl. No.: 18/932,553

(22) Filed: Oct. 30, 2024

(51) Int. Cl. G08G 1/087; G08G 1/095

(52) U.S. Cl. CPC G08G 1/087; G08G 1/095

(57) ABSTRACT

A traffic pickle device is an electronic device that includes a box containing circuitry, a battery, and a mono jack. The box is in electronic communication with a wireless remote control. The circuitry is configured for wireless and wired applications. The circuitry for wireless applications comprises a relay disposed therein to generate and transmit signals remotely to the wireless remote control. A signal of the generated and transmitted signals is simulating a momentary button press. The circuitry for wired applications comprises hard-wired connections connected to the battery and the mono jack.

### TECHNICAL FIELD

The embodiments generally relate to electronic devices, and more specifically to a traffic control system.

### BACKGROUND

A Traffic Control Manual Light Changing Remote, commonly known as a “pickle”, is a device designed for the manual operation of traffic light cycles. Current pickles have a corded button system that is confining to the user of said pickles.

### SUMMARY OF THE INVENTION

This summary is provided to introduce a variety of concepts in a simplified form that is further disclosed in the detailed description of the embodiments. This summary is not intended for determining the scope of the claimed subject matter.

In the embodiments provided herein, a traffic pickle device is disclosed. The traffic pickle device includes a box containing circuitry, a battery, and a connection to a mono jack; and a wireless remote. The circuitry is configured for wireless applications and wired applications.

The circuitry configured for wireless applications comprises a relay disposed therein to generate and transmit signals remotely to the wireless remote. A signal of the signals is simulating a momentary button press. The circuitry configured for wired applications comprises hard-wired connections connected to the battery and the mono jack.

In some aspects, the battery is a rechargeable battery of variable voltage.

In some aspects, the box is a waterproof enclosure.

In some aspects, the relay is built onto an electronic board.

In some aspects, the wireless remote control comprises buttons for power and operation.

In some aspects, a battery life meter is also included with the traffic pickle device.

In some aspects, the mono jack is configured for plugging into a traffic control device, the term ‘traffic control device’ refers to existing infrastructure, such as traffic signals or traffic lights, which are managed by the traffic pickle device.

In some aspects, the traffic control device undergoes a switch between a first state to a second state.

In some aspects, the switch from the first state to the second state actuates the wireless remote control.

In some aspects, the wireless remote is permitted to control the traffic control device, when the traffic control is in the second state.

In some aspects, the switch from the second state to the first state de-actuates the wireless remote control.

In some aspects, the wireless remote is blocked from controlling the traffic control device, when the traffic control is in the first state.

In some aspects, the relay and the electronics board, when pressed against each other, transmit a signal to the wireless remote, thereby activating the relay.

In some aspects, activating the relay is simulating a button on a wired control being pressed.

In some aspects, simulating the momentary button press occurs when the relay is activated.

In some aspects, the traffic control device has a first communication radius associated with a wired control and a second communication radius associated with the wireless remote control. The second communication radius is larger than the first communication radius.

In some aspects, the traffic pickle device also includes epoxy as a protective coat for the wiring.

In some aspects, the traffic pickle device also includes a USB (universal serial bus) charging cord, barrel jacks, or the USB charging cord and barrel jacks.

In some aspects, the wired control is a fixed position setup and the wireless remote control is a variable position setup.

In some aspects, the connection is a cord extending from the box.

The embodiments provided herein disclose a traffic pickle system, which wirelessly connects to a control, thereby obviating existing corded button system. More particularly, the traffic pickle system described herein provides greater flexibility and convenience to traffic control operators. The traffic pickle system device described herein utilizes a wireless relay and remote-control system, allowing for operation from a greater distance and freeing operators from the constraints/confines of a physical cord. The compact, portable design is enclosed in a waterproof casing, ensuring durability and reliability in various weather conditions. Powered by, for example, a rechargeable 3.7-volt battery, the traffic pickle system described herein connects to existing traffic control boxes via a standard 6.35 mm mono jack, seamlessly integrating with current infrastructure.

Unlike a pigtail cord button that plugs into the traffic control device, which is manually operated by the press of a button at the end of the cord, the traffic pickle system described herein is a box wirelessly connecting to a control via a relay in the box.

Unlike filamentation attached to a cord which the user would not have the ability to go further than a radius allowed by the cord, to control, for example, traffic light, the traffic pickle system described herein has the control wirelessly controlled by relay in the box can go further than a radius imposed by a physical cord.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a box and remote control of traffic pickle device, according to some embodiments;

FIG. 2 illustrates the battery and the relay residing on an electronic board, according to some embodiments.

FIG. 3 illustrates a box with a battery life meter, according to some embodiments;

FIG. 4 illustrates the internals of the box with the battery life meter, according to some embodiments; and

FIG. 5 illustrates the internals of the box without the battery life meter, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to the traffic pickle device described herein, which is a system that has a boxed encasing with a relay for controlling or actuating/de-actuating, for example, a manual light changing remote that is wireless. The manual light changing remote has, for example, a traffic light changing button. The traffic pickle system described herein allows anyone with access to a traffic control box to manually operate a traffic lights cycle, with the press of the button on the remote, which is wirelessly connected to the boxed encasing of the traffic pickle system described herein.

The traffic pickle device described herein is an electronic device that includes a boxed encasing containing circuitry, a battery, and a mono jack. The box is in electronic communication with a wireless remote. The circuitry comprises circuitry for wireless applications and circuitry for wired applications. The circuitry for wireless applications comprises a relay disposed therein to generate and transmit signals remotely to the wireless remote. A signal of the generated and transmitted signals is simulating a momentary button press. The wired circuitry for wired applications comprises hard-wired connections connected to the battery and the mono jack.

It is to be understood that the specific measurements used below are provided by way of example and are not intended to limit the scope of the embodiments disclosed herein. The exemplary measurements serve to provide an exemplary embodiment of the traffic pickle device capable of providing the functions described in this disclosure.

In some embodiments, the traffic pickle device described herein has a box (i.e., an enclosure) encasing the circuitry and electronic components, a battery, and a mono jack, wherein the box is wirelessly connected to a remote control. The box, which can have measurements of 3.94×2.68×1.97 inch (100×68×50 mm), is composed of water resistant material and weather resistant material, such as Acrylonitrile Butadiene Styrene, while according with Ip65 specifications.

In some embodiments, the circuitry for wireless application and electronic components can be a relay proximal to a printed electronic circuit board. The dimensions for the circuit board are 5″×3″×0.5″, whereby the relay board can operate on variable voltages, but works best between 3.7 to 5 volts. Additionally, the relay which is normally under an “open” state, does not carry any current from the device to the connection point.

In some embodiments, the wiring circuitry and electronic components can be the battery and the mono jack, wherein the battery is a rechargeable 3.7 volt (V) battery, and wherein the mono jack is a 6.35 millimeter (mm) jack. Note: While the rechargeable 3.7 V battery is a preferred embodiment, the battery is not limited to 3.7 V. Batteries of variable voltages can be used, such as 3.5 V, 3.6 V, 3.8 V, 3.9 V, 4.0 V, 4.1 V, 4.2 V, 4.3 V, 4.4 V, 4.5 V, 4.6 V, 4.7 V, 4.8 V, 4.9 V, 5.0 V, or higher than 5.0 V. While the 6.35 mm jack can be used in the preferred embodiment, other jack sizes can be used that accord with different peripheral configurations.

In some embodiments, the remote control has a button that can be used to control the traffic control system, when the mono jack is connected to the traffic control system. The remote control is 12V 5V Mini Size Relay Remote Control Switch, 433 Mhz Wireless RF (radio frequency) Momentary Switch with Delay Function, Transmitter and Receiver for Wireless Control, which is 5.28×2.99×0.47 inches and weighs 1.13 ounces. The receiver and transmitter within the remote control work within the following parameters: a frequency of 433 Mhz; a working current of ≤12 mA; and a transmission distance of 10-50 Meters, a max load of 1 amp (have better Load less than 700 milliamps(ma)); a quiescent current of 5 ma; and a relay working current of 30 ma.

During use, the traffic pickle device described herein has the following features: a wireless traffic management tool; remote traffic light cycle adjuster; traffic intersection management where a jack plugs into a traffic control box and weatherproof traffic box. These features lead to the following functionalities: wireless manual override of traffic light cycles; remote signal transmission to traffic control box; momentary relay activation simulating button press; and integration with existing traffic control systems.

Advantages of the traffic pickle device described herein allows the user more mobility to control a traffic light, as opposed to being stuck with the limitations of the cord, which has a predefined communication radius between the control with a cord and the traffic light. Several benefits to this would be not having to stand in the hot sun and getting a suntan on the neck, due to variable radius between the control with a cord and the traffic light, as permitted by the traffic pickle device, while operating a traffic control light for hours; and allowing the operator to be inside of their vehicle during inclement weather situations and not having to stand out and the rain operating the traffic control light. Accordingly, there is a reduction in physical strain and fatigue, which improves safety in challenging weather conditions, and increases overall operational efficiency. The traffic pickle device described herein has compatibility with existing traffic control systems, thereby ensuring a smooth transition and widespread applicability. As a result, the traffic pickle device described herein represents an advancement in traffic management technology, offering a more flexible, comfortable, and efficient solution for manually controlling traffic lights while maintaining the reliability and functionality of traditional systems.

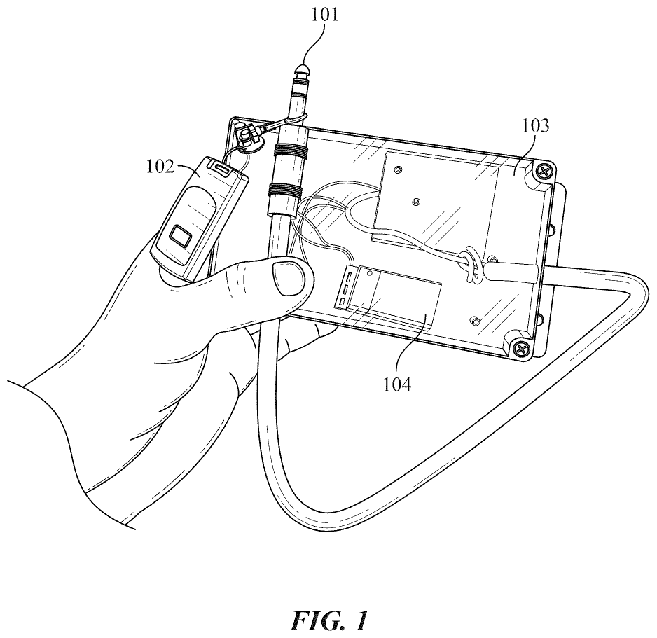

In FIG. 1, the traffic pickle device is illustrated. The operation of the traffic pickle device involves a jack 101 (e.g., 6.35 mm mono jack), which plugs into a traffic control box (i.e., the cord that comes out of the traffic pickle device that plugs into the traffic control device). Once the jack 101 is plugged in and the traffic control box switches from an automatic mode into manual mode, wireless remote control 102 can be: (i) turned on and operated from that point forward (i.e., wireless remote control 102 is actuated), whereby (ii) the traffic control device is switched on before the traffic control device can receive the remote input to close the relay, until (iii) the traffic control box is placed back into the automatic mode (i.e., wireless remote control 102 is de-actuated). In the automatic mode, the computer in the traffic control box resumes control over managing intersections, thereby de-actuating wireless remote control 102. The material of encasing box 103 comprise a waterproof enclosure, which can be turned on and off.

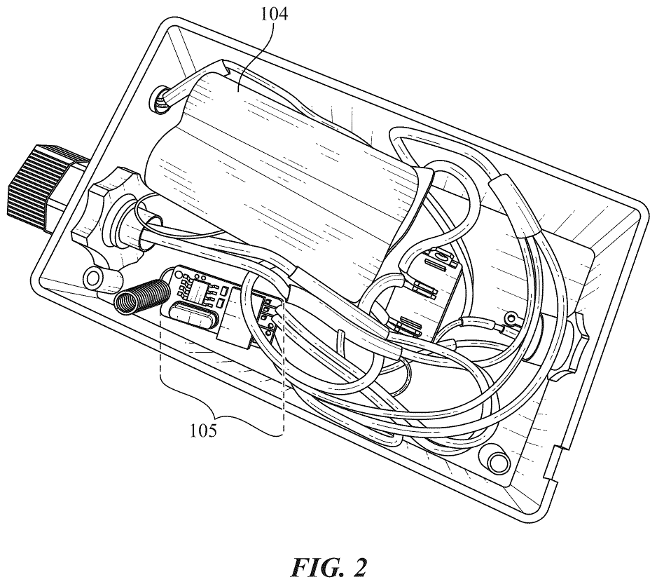

In FIG. 2, the box of the traffic pickle device is illustrated. The traffic pickle device is a smaller box frame that is powered by battery 104 (e.g., a 3.7 volt battery that is rechargeable and is contained within a waterproof enclosure), wherein there is circuitry configured for wireless applications and circuitry configured for wired applications. The circuitry configured for wireless applications comprises a simple wireless relay with wireless remote control 102. Relay 105 is built onto the electronics board to generate and send signals in a momentary fashion. When relay 105 is pressed against the electronic boards, relay 105 is momentarily activated or actuated. Relay 105 acts as the button that is pressed on the corded remote control simulating a momentary press. There are multiple buttons, such as those buttons that power on the traffic pickle and device and button on wireless remote control 102 that operates the device.

In addition to jack 101 and relay 105, encasing box 103 comprises: battery 104, which is a battery that is rechargeable; electronic potting epoxy to protect the wiring and the electronics from water damage; a USB charging cord; and barrel jacks for the charging mechanism.

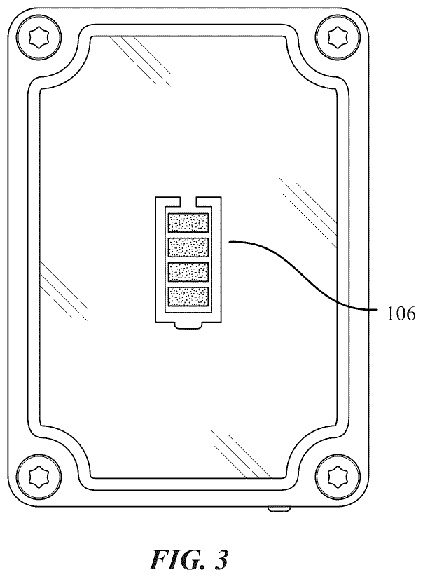

In FIG. 3, an enhanced model of the traffic pickle device is depicted, wherein the enhanced model includes a battery life meter 106.

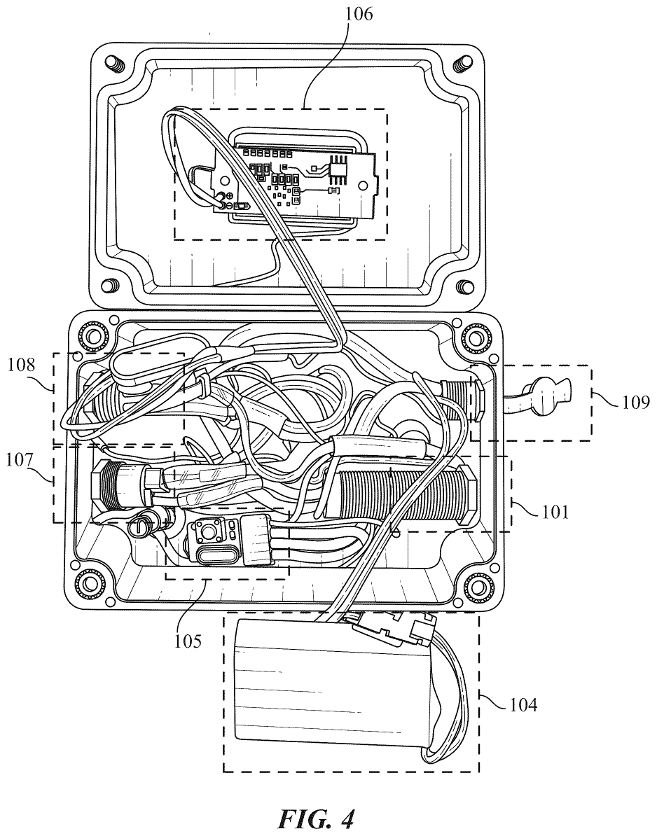

In the enhanced model of the traffic pickle device, as illustrated in FIG. 4 and FIG. 5, additional features have been integrated to improve user functionality and device performance. This model includes a battery life meter 106 that provides real-time feedback on the remaining power. Additionally, a power switch 107 has been added, allowing for convenient activation and deactivation of the device. A momentary switch 108 has also been included to facilitate quick checks of the battery life meter without the need to connect or disconnect the device form the traffic control system. Further, the model incorporates a charging port 109 designed for easy and efficient recharging of the integrated battery 104.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A traffic pickle device, comprising:
a box containing circuitry, a battery, and a connection to a mono jack; and
a wireless remote control;
wherein the circuitry is operable for wireless applications and wired applications;
wherein the circuitry configured for wireless applications comprises a relay disposed therein to generate and transmit signals remotely to the wireless remote control, wherein a signal of the signals is simulating a momentary button press;
wherein the circuitry configured for wired applications comprises hard-wired connections connected to the battery and the mono jack.

2. The traffic pickle device of claim 1, wherein the battery is a rechargeable battery of variable voltage.

3. The traffic pickle device of claim 2, wherein the box is a waterproof enclosure.

4. The traffic pickle device of claim 1, wherein the relay is built onto an electronic board.

5. The traffic pickle device of claim 1, wherein the wireless remote control comprises buttons for power and operation.

6. The traffic pickle device of claim 1, further comprises a battery life meter.

7. The traffic pickle device of claim 1, further comprising a power switch for activating and deactivating the device.

8. The traffic pickle device of claim 1, further comprising a momentary switch for checking battery life without disconnecting the device.

9. The traffic pickle device of claim 1, further comprising a charging port for recharging the battery.

10. The traffic pickle device of claim 1, wherein the mono jack is configured for plugging into a traffic control device.

11. The traffic pickle device of claim 10, wherein the traffic control device undergoes a switch between a first state to a second state.

12. The traffic pickle device of claim 11, wherein the switch from the first state to the second state actuates the wireless remote control.

13. The traffic pickle device of claim 12, wherein the wireless remote control is permitted to control the traffic control device, when the traffic control is in the second state.

14. The traffic pickle device of claim 13, wherein activating the relay is simulating a button on a wired control being pressed.

15. The traffic pickle device of claim 1, wherein simulating the momentary button press occurs when the relay is activated.

16. The traffic pickle device of claim 7, wherein the traffic control device has a first communication radius associated with a wired control and a second communication radius associated with the wireless remote control, wherein the second communication radius is larger than the first communication radius.

17. The traffic pickle device of claim 1, further comprising epoxy as protective coat for the wiring.

18. The traffic pickle device of claim 1, further comprising a USB charging cord, barrel jacks, or the USB charging cord and barrel jacks.

19. The traffic pickle of claim 16, wherein the wired control is a fixed position setup and the wireless remote control is a variable position setup.

20. The traffic pickle of claim 1, wherein the connection is a cord extending from the box.
